(19) United States
(12) Patent Application Publication
(10) Pub. No.: US 2023/0359209 A1
(43) Pub. Date: Nov. 9, 2023

(54) STABILITY SYSTEM FOR AN ARTICULATED MACHINE

(71) Applicant: CATERPILLAR INC., Peoria, IL (US)

(72) Inventors: Aaron Robert Shatters, Montgomery, IL (US); Eric W. Cler, Oswego, IL (US)

(73) Assignee: CATERPILLAR INC., PEORIA, IL (US)

(21) Appl. No.: 17/737,370

(22) Filed: May 5, 2022

(51) Int. Cl. G05D 1/02; G05D 1/00

(52) U.S. Cl. CPC G05D 1/0214; G05D 1/0223; G05D 1/0094; G05D 2201/0202

(57) ABSTRACT

The real time state and stability of a machine are determined and the future stability of the machine is predicted based on different potential machine operations. Sensor inputs including machine speed and acceleration, lift height of a payload, an articulation angle of the machine, a position of the machine, a pitch angle and a roll angle of the machine are used to generate a model for estimating a time series of real time and future values for the degree of stability of the machine by solving a kinematic equation and inputting other machine operational parameters during a timestep of a series of timesteps based at least in part on an estimate of the location of the center of gravity of a first portion of the machine in combination with the payload carried by the machine relative to a predetermined point, and the location of the center of gravity of a second portion of the machine relative to the predetermined point in a subsequent timestep. Visible or audible indications of the machine's current degree of stability and hypothetical future degrees of stability at different potential states of the machine are output.

### TECHNICAL FIELD

The present disclosure relates generally to a machine stability system and, more particularly, to a stability system for an articulated machine.

### BACKGROUND

Machines such as, for example, dozers, motor graders, wheel loaders, wheel tractor scrapers, and other types of heavy equipment are used to perform a variety of tasks. Effective control of the machines requires accurate and responsive sensor reading to perform calculations providing information in near real time to the machine control or operator. Autonomously and semi-autonomously controlled machines are capable of operating with little or no human input by relying on information received from various machine systems. For example, based on machine movement input, terrain input, and/or machine operational input, a machine can be controlled to remotely and/or automatically complete a programmed task. By receiving appropriate feedback from each of the different machine systems and sensors during performance of the task, continuous adjustments to machine operation can be made that help to ensure precision and safety in completion of the task. In order to do so, however, the information provided by the different machine systems and sensors should be accurate and reliable. The position, velocity, and distance traveled by the machine, and positions, movements, and orientations of the machine itself and different parts or components of the machine are parameters whose accuracy may be important for control of the machine and its operations.

Machines, such as an articulated wheel loader, carry varying payloads at varying speeds, grades, and side-slopes. When traveling while carrying a payload, the machine, such as an articulated wheel loader, may suspend the load at varying lift heights and at varying machine steering articulation angles. In addition, the machine itself may be subjected to varying acceleration rates and deceleration rates as an operator operates machine propulsion and braking systems, either while onboard the machine in an operator cab, or from offboard the machine when operating the machine semi-autonomously from a remote location. If the load being carried is quite heavy, the weight of a front portion of the machine and the load may not be adequately offset by the rear portion of the machine, thus causing an unstable condition. This condition may also occur when, for example, a wheel loader is picking up a portion of a load from a pile. In these types and similar instances, the stability of the wheel loader may be less than optimal, sometimes causing the rear wheels of the wheel loader to lift from the ground, thus creating a potentially dangerous situation and providing discomfort to the operator. In extreme conditions the wheel loader can tip over. Each state of the machine results in a certain degree of stability (or instability). If an operator, in the case of a non-autonomously or semi-autonomously operated machine, or a controller, in the case of a fully autonomously operated machine, operates the machine without knowledge of the machine's degree of stability, the machine may be controlled in such a way that the margin of stability decreases enough for the machine to tip over. This problem may be particularly acute when a human operator is operating the machine from a remote location without the benefit of innate human senses of proprioception and stability that are present when the human is on the machine, or when a machine is being controlled fully autonomously by computer processes.

Conventional machines typically utilize a navigation or positioning system to determine various operating parameters such as position, velocity, pitch rate, yaw rate, and roll rate for the machine. The position and orientation of the machine is referred to as the “pose” of the machine. The machine “state” includes the pose of the machine as well as various additional operating parameters that can be used to model the kinematics and dynamics of the machine, such as parameters characterizing the various links, joints, tools, hydraulics, and power systems of the machine. Some conventional machines utilize a combination of one or more of Global Navigation Satellite System (GNSS) data, a Distance Measurement Indicator (DMI) or odometer measurement data, Inertial Measurement Unit (IMU) data, etc. to determine these parameters. Some machines utilize RADAR sensors, SONAR sensors, LIDAR sensors, IR and non-IR cameras, and other similar sensors to help guide the machines safely and efficiently along different kinds of terrain. Conventional machines have attempted to fuse these different types of data to determine the position of a land-based vehicle.

An exemplary system that may be utilized to determine the position of a machine is disclosed in U.S. Patent Application Publication No. 2008/0033645 (“the '645 publication”) to Levinson et al. that published on Feb. 7, 2008. The system of the '645 publication utilizes location data from sensors such as Global Positioning System (GPS), as well as scene data from a LIDAR (light detection and ranging) device to determine a location or position of the machine. Specifically, the data is used to create a high-resolution map of the terrain and the position of the machine is localized with respect to the map.

Although the system of the '645 publication may be useful in determining the position of a machine, the system does not provide estimates for the stability of an articulated machine in different present or potential future states such as when the machine is carrying a payload at different lift heights with one part of the machine articulated relative to another part of the machine and/or the machine is operating at different pitch angles or roll angles relative to a direction of gravity. The system and method for determining the degree of stability of a machine in different machine states using sensor fusion and data acquired by a variety of sensors including weight or payload, speed and/or acceleration of the machine, lift height of the payload, articulation angle between two portions of the machine, pitch angle of the machine, and roll angle of the machine, according to the present disclosure is directed toward solving one or more of the problems set forth above and/or other problems of the prior art.

### SUMMARY

In one aspect, the present disclosure is directed to a method of determining the real time state and stability of a machine, determining a threshold value for an acceptable degree of stability of the machine based on different potential machine states or operations, and notifying an operator of the present and future stability of the machine at different potential states of the machine. The method includes receiving, with at least one processor, from each of a plurality of sensors mounted on different elements or portions of the machine, a time series of signals indicative of the relative orientations for each of the elements or portions of the machine on which one or more of the plurality of sensors are mounted. The method also includes fusing a series of measurements made over time by each of the sensors on the machine with a Kalman filter module of the at least one processor. The fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, a pitch angle of the machine, and a roll angle of the machine relative to a direction of gravity to form a model for estimating a stability of the machine during a timestep of a series of timesteps. The method further includes generating the model for estimating the stability of the machine based on an a priori estimate of the location of the center of gravity of a first portion of the machine in combination with the payload carried by the machine relative to a predetermined point, and the location of the center of gravity of a second portion of the machine relative to the predetermined point in a subsequent timestep. The method still further includes combining the a priori estimate of the locations of the centers of gravity of the first and second portions of the machine with an estimate of the accuracy of the a priori estimate and a current measurement value received from the plurality of sensors to produce a refined a posteriori estimate of the locations of the centers of gravity of the first and second portions of the machine. The method further includes fusing the refined a posteriori estimates of the locations of the centers of gravity of the first and second portions of the machine with each other and in reference to a machine reference frame to determine best estimates of the degree of stability of the machine, determining real time values for the degree of stability of the machine and a threshold value for an acceptable level of the degree of stability of the machine by one or more of solving a physics-based equation or retrieving data from a lookup map or other database using the best estimates of current degree of stability of the machine and structural design information characterizing the machine, and determining from the solution of the physics-based equation or retrieved data and other machine operational parameters including speed and acceleration of the machine, a time series of values for the degree of stability of the machine at successive timesteps of the series of timesteps. The method still further includes outputting a visible or audible indication of the machine's current degree of stability and hypothetical future degrees of stability at different potential states of the machine.

In another aspect, the present disclosure is directed to a system for determining the real time state and stability of a machine, predicting the future stability of the machine based on different potential machine operations, and notifying an operator of the future stability of the machine at different potential states of the machine. The system includes a plurality of sensors mounted on separate elements or portions of the machine, and at least one processor. The at least one processor is configured to receive from each of a plurality of sensors mounted on different elements or portions of the machine, a time series of signals indicative of the positions and orientations for each of the elements or portions of the machine on which one or more of the plurality of sensors are mounted. The at least one processor is also configured to fuse a series of measurements made over time by each of the sensors on the machine with a Kalman filter module of the at least one processor. The fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, a pitch angle of the machine, and a roll angle of the machine relative to a direction of gravity to form a model for estimating a stability of the machine during a timestep of a series of timesteps. The at least one processor is still further configured to generate the model for estimating the stability of the machine based on an a priori estimate of the location of the center of gravity of a first portion of the machine in combination with the payload carried by the machine relative to a predetermined point, and the location of the center of gravity of a second portion of the machine relative to the predetermined point in a subsequent timestep, combine the a priori estimate of the locations of the centers of gravity of the first and second portions of the machine with an estimate of the accuracy of the a priori estimate and a current measurement value received from the plurality of sensors to produce a refined a posteriori estimate of the locations of the centers of gravity of the first and second portions of the machine, and fuse the refined a posteriori estimates of the locations of the centers of gravity of the first and second portions of the machine with each other and in reference to a machine reference frame to determine best estimates of the degree of stability of the machine. The at least one processor is also configured to one or more of solve a physics-based equation or retrieve data from a lookup map or other database using the best estimates of current degree of stability of the machine and structural design information characterizing the machine, and determine from the solution of the physics-based equation or retrieved data and other machine operational parameters including speed and acceleration of the machine, a time series of real time and future values for the degree of stability of the machine at successive timesteps of the series of timesteps. The at least one processor is still further configured to output a visible or audible indication of the machine's current degree of stability and hypothetical future degree of stability at different potential states of the machine.

In yet another aspect, the present disclosure is directed to an articulated machine including a system for determining the real time state and stability of a machine, predicting the future stability of the machine based on different potential machine operations, and notifying an operator of the future stability of the machine at different potential states of the machine. The system includes a plurality of sensors mounted on separate elements or portions of the machine, and at least one processor. The at least one processor is configured to receive from each of the plurality of sensors mounted on different elements or portions of the machine, a time series of signals indicative of the positions and orientations for each of the elements or portions of the machine on which one or more of the plurality of sensors are mounted. The at least one processor is also configured to fuse a series of measurements made over time by each of the sensors on the machine with a Kalman filter module of the at least one processor. The fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, a pitch angle of the machine, and a roll angle of the machine relative to a direction of gravity to form a model for estimating a stability of the machine during a timestep of a series of timesteps. The at least one processor is still further configured to generate the model for estimating the stability of the machine based on an a priori estimate of the location of the center of gravity of a first portion of the machine in combination with the payload carried by the machine relative to a predetermined point, and the location of the center of gravity of a second portion of the machine relative to the predetermined point in a subsequent timestep, combine the a priori estimate of the locations of the centers of gravity of the first and second portions of the machine with an estimate of the accuracy of the a priori estimate and a current measurement value received from the plurality of sensors to produce a refined a posteriori estimate of the locations of the centers of gravity of the first and second portions of the machine, and fuse the refined a posteriori estimates of the locations of the centers of gravity of the first and second portions of the machine with each other and in reference to a machine reference frame to determine best estimates of the degree of stability of the machine. The at least one processor is also configured to solve a physics-based equation or retrieve data from a lookup map or other database using the best estimates of current degree of stability of the machine and structural design information characterizing the machine, and determine from the solution of the physics-based equation or retrieved data and other machine operational parameters including speed and acceleration of the machine, a time series of real time and future values for the degree of stability of the machine at successive timesteps of the series of timesteps. The at least one processor is still further configured to output a visible or audible indication of the machine's current degree of stability and hypothetical future degree of stability at different potential states of the machine.

### BRIEF DESCRIPTION OF THE DRAWINGS

FIG. 1 is a pictorial illustration of an exemplary disclosed machine, which may be operated using a system and method for determining the real time state and stability of the machine according to exemplary embodiments of this disclosure;

FIG. 2 is a diagrammatic illustration of an exemplary disclosed sensor fusion system for determining the state and stability of the machine of FIG. 1;

FIG. 3 is a flow chart illustrating an exemplary application of the outputs from the sensor fusion system of FIG. 2 in determining stability of the exemplary disclosed machine of FIG. 1, and notifying an operator of potential future stability at different machine states;

FIG. 4 is a diagrammatic illustration of a system for notifying an operator of future stability of the exemplary disclosed machine of FIG. 1 at different potential machine states; and

FIG. 5 is a flow chart illustrating an exemplary application of the outputs from the sensor fusion system of FIG. 2 for automatically controlling the machine while maintaining machine stability in a situation when the machine is in a coasting mode.

### DETAILED DESCRIPTION

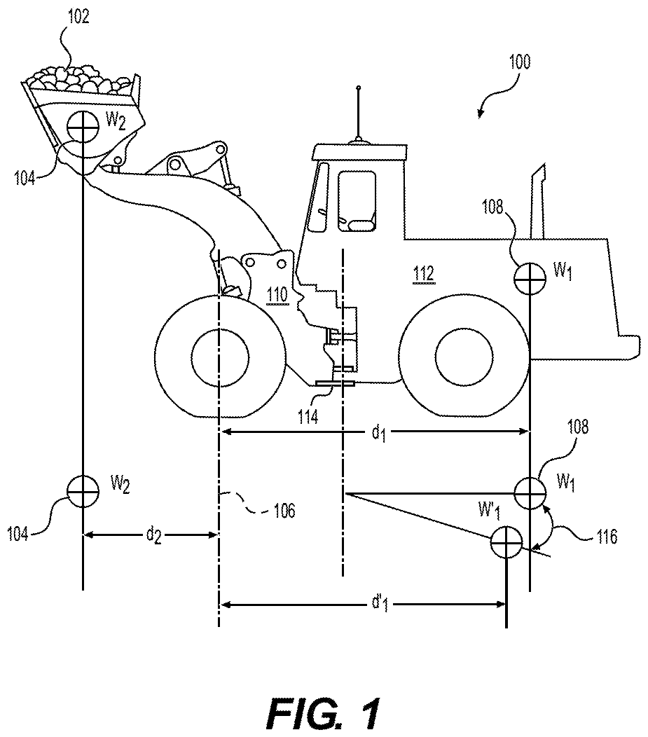

FIG. 1 illustrates an exemplary machine 100 in the form of an articulated wheel loader, configured to carry a payload 102 in a bucket, with a center of gravity 104 of the combination of payload 102 and a predetermined front portion of machine 100 being located at a distance d₂ from a predetermined point 106, for example, a predetermined point 106 along a vertical axis passing through the center of a front wheel of machine 100. Machine 100 may include a front sensor system, a rear sensor system, and controller (CPU) 200. The front sensor system may include a plurality of sensors configured to produce a fused front signal indicative of the location of the center of gravity 104 of the combination of the payload 102 and the predetermined front portion of the machine 100 relative to the predetermined point 106. The rear sensor system may include a plurality of sensors configured to produce a fused rear signal indicative of the location of a center of gravity 108 of a predetermined rear portion of the machine 100 relative to the predetermined point 106. Controller (CPU) 200 may be configured to receive the front signal and the rear signal, compare the front signal and the rear signal to predetermined values, and responsively produce an output signal 202.

Machine 100 may include a first frame 110, a second frame 112, an articulation joint 114 at the connection between first frame 110 and second frame 112, a lift height sensor 201 for determining the height at which the bucket is holding payload 102, an articulation sensor 204, a weight sensor 208, a position sensor 212, a pitch angle sensor 213, a roll angle sensor 217, a bubble level sensor 221, a controller (CPU) 200, and an output device 216. Articulation joint 114 may have an articulation angle 116, which indicates the positional relationship between first frame 110 and second frame 112. Lift height sensor 201 may be configured to sense the lift height of payload 102 in the bucket of machine 100 and responsively produce a lift height signal 203. Articulation sensor 204 may be configured to sense articulation angle 116 and responsively produce an articulation angle signal 206. Weight sensor 208 may be one or more sensors configured to sense the weight of payload 102 and the weight of the entire machine or portions of the machine carried by one of first frame 110 and second frame 112, and responsively produce a weight signal 210. Position sensor 212 may be configured to sense the position of payload 102 in relation to one or more portions of the machine 100 (e.g., the bucket, the first frame 110, the second frame 112, the articulation joint 114) or in relation to a ground surface, and responsively produce a position signal 214. Pitch angle sensor 213 may be configured to sense the pitch angle of machine 100 and responsively produce a pitch angle signal 215, representative of the amount of rotational motion of machine 100 about a transverse axis. Roll angle sensor 217 may be configured to sense the roll angle of machine 100 and responsively produce a roll angle signal 219, representative of the amount of rotational motion of machine 100 about a longitudinal axis. In some exemplary embodiments, a bubble level sensor 221 may be mounted on machine 100 and configured to sense an overall orientation or levelness of machine 100, and responsively produce a bubble level signal 223. In some exemplary embodiments, an onboard sensor may be configured to sense machine speed, and responsively produce corresponding speed data. Controller 200 may be configured to receive lift height signal 203, articulation angle signal 206, weight signal 210, position signal 214, pitch angle signal 215, roll angle signal 219, and bubble level signal 223, and responsively provide an output signal 202. Output signal 202 may then be communicated by controller 200 to an output device 216. Preferably, the output device is at least one of: a visible device, such as a light or a display configured to show an operator gradations of color or other visual signifiers for notifying the operator of varying degrees of stability of the machine at different present and future potential states of the machine; an audible device, such as a bell, whistle, or horn, configured to provide an operator with variations in sound stimuli for notifying the operator of varying degrees of stability of the machine at different present and future potential states of the machine; a tactile device; or a machine control device, such as a steering or braking system. Controller 200 may be one of many readily available computers capable of processing numerous instructions. It should be appreciated that controller 200 may include multiple processing units configured in a distributed structure environment and forming a system.

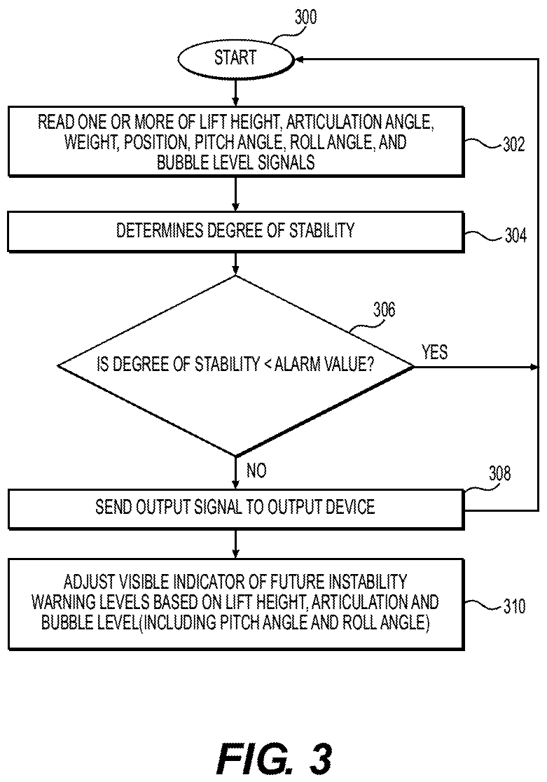

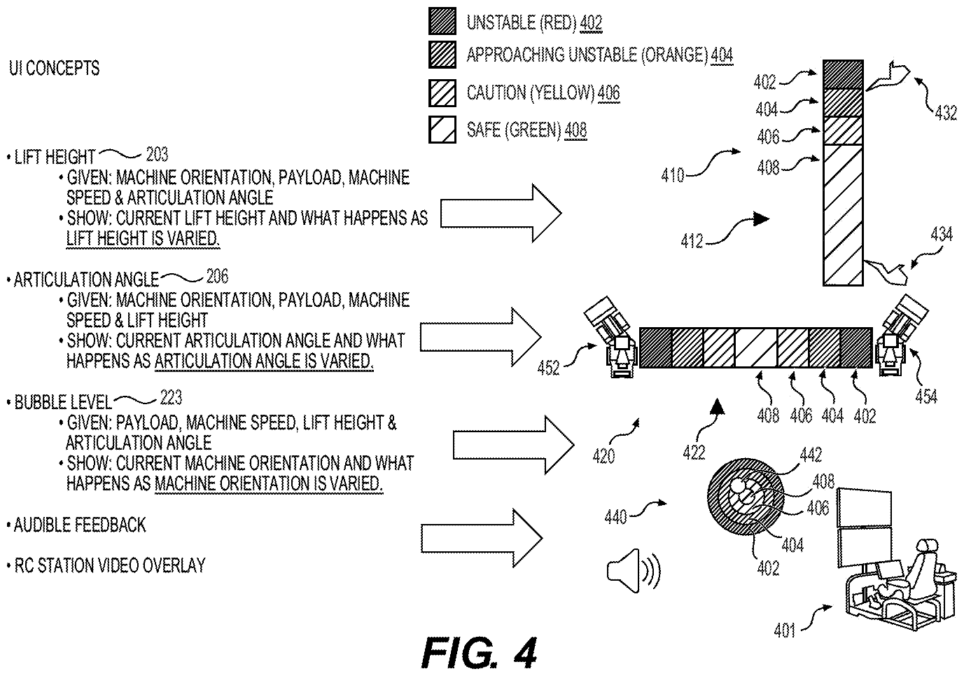

Predetermined values (e.g., predetermined values corresponding to the fused front and rear signals) used by controller 200 may be taken from a table, a formula, an algorithm, or any combination thereof. Controller 200 is commonly known as a central processing unit (CPU) or an electronic control module (ECM). In a preferred embodiment, the controller is a microprocessor. However, other suitable controllers are known in the art, any one of which could be used in connection with an embodiment of the present disclosure. A specific program code can be written, for example, from the flow chart, shown in FIG. 3, in the specific assembly language or microcode for the selected microprocessor. FIG. 3 illustrates a flow chart of the logic of an exemplary implementation of the present disclosure. The logic starts at the start block 300. Controller 200 then proceeds to the read block 302 in which it reads one or more of lift height signal 203, articulation angle signal 206, weight signal 210, position signal 214, pitch angle signal 215, roll angle signal 219, and bubble level signal 223. Next, controller 200 determines the degree of stability value at the stability block 304. In comparison block 306, controller 200 compares the degree of stability value to an alarm value. If the degree of stability value is less than the alarm value, controller 200 returns to the start block 300. If the degree of stability value is greater than or equal to the alarm value, controller 200 sends an output signal 202 to the output device or devices 216 in block 308. As illustrated in block 310 of FIG. 3, and in FIG. 4, an exemplary output from output device or devices 216 may include adjusting a visible indicator of future instability warning levels based on the fused signals discussed above.

Various exemplary embodiments of displays or portions of displays that may be shown to an operator of machine 100 by output device 216 are illustrated in FIG. 4. In one exemplary embodiment, a visual display 410, such as shown at the top of FIG. 4, may focus on the degree of instability of machine 100 that may result as a function of potential future lift heights of a payload being carried by machine 100. A representative symbol of a bucket is shown at a high lift height 432 near the top of a vertical bar, and at a low lift height 434 near the bottom of the vertical bar. Output device 216 may be configured to present a vertical bar that displays gradations of color or other visual signifiers, e.g., from an upper red zone 402, representative of an unstable state, near a top of the vertical bar, at which a bucket is carrying a payload at high lift height 432, through sequentially lower zones, including an orange zone 404, representative of approaching an unstable state, a yellow zone 406, representative of a zone where caution should be observed, to a lower green zone 408, representative of a safe state, at which a bucket is carrying a payload at low lift height 434. An arrow 412 may indicate a present state of machine 100, with a degree of instability that is located in lower green zone 408, when the bucket carrying payload 102 is positioned in between high lift height 432 and low lift height 434. Such a display may allow an operator to quickly and intuitively appreciate the effect on potential stability of machine 100 caused by lift height when carrying payload 102 in a bucket. Controller 200 may be configured to fuse the signals received from various sensors, taking into consideration machine orientation, payload, machine speed, articulation angle, and other operational and kinematic characteristics in determining the effect lift height 203 will have on the stability of machine 100.

In addition to, or instead of the vertical bar display shown at the top of FIG. 4, illustrating the effect payload lift height may have on the degree of instability of machine 100, controller 200 may be configured to display a horizontal bar, such as shown in the middle of FIG. 4, focusing on the degree of instability of machine 100 that may result as a function of potential future articulation angles between a front portion of machine 100, including a bucket carrying a payload 102, and a rear portion of machine 100. A representative symbol of machine 100 with the front portion articulated all the way to the left may be shown at the left side 452 of the horizontal bar, and a representative symbol of machine 100 with the front portion articulated all the way to the right may be shown at the right side 454 of the horizontal bar. Output device 216 may be configured to present the horizontal bar with gradations of color from far left and far right red zones 402, representative of unstable states when machine 100 is fully articulated to the left or to the right while the bucket is carrying a payload, through sequentially less articulated zones, including orange zones 404, representative of approaching an unstable state, yellow zones 406, representative of machine states where caution should be observed, to a middle green zone 408, representative of a safe state, at which an articulation angle of machine 100 is approaching zero degrees, with a bucket of machine 100 carrying a payload while machine 100 is traveling straight forward or rearward. An arrow 422 may indicate an exemplary present state of machine 100, with a degree of instability that is located in yellow caution zone 406, when machine 100 is only partially articulated to the left while the bucket is carrying payload 102. Such a display may allow an operator to quickly and intuitively appreciate the effect on potential stability of machine 100 caused by a change in articulation angle 206. Controller 200 may be configured to fuse the signals received from various sensors, taking into consideration machine orientation, payload, machine speed and acceleration, payload lift height, and other operational and kinematic characteristics in determining the effect articulation angle 206 may have on the stability of machine 100.

FIG. 4 also illustrates an exemplary display at the lower portion of FIG. 4, in which controller 200 may be configured to output a display in the form of a bubble level indicator 440. Bubble level indicator 440 may be generated by controller 200 based on a fusion of data input from sensors providing information on payload, machine speed and acceleration, lift height, articulation angle, and machine orientation, with potential degrees of instability of machine 100 represented by concentric rings, transitioning from an inner circular green zone 408, representative of a safe state with a low degree of instability, through an inner concentric yellow ring 406 surrounding inner circular green zone 408, representative of a state with a higher degree of instability where caution should be exercised during operation of machine 100, through a middle concentric orange ring 404 surrounding yellow ring 406, representative of a state that is approaching an unstable state, to an outer concentric red ring 402 surrounding orange ring 404, representative of an unstable state. In the example illustrated by bubble level indicator 440 in FIG. 4, a present state of machine 100 is shown at 442, positioned in the inner concentric yellow ring 406, representative of a state where the operator should exercise caution to avoid further increasing the potential degree of instability of machine 100. An operator may know intuitively that increasing the lift height of a payload carried in a bucket of machine 100 and/or increasing an articulation angle of machine 100 could both contribute to an increase in the degree of instability of machine 100. The operator would then exercise a greater degree of caution with regard to further increasing the lift height or further increasing the articulation angle of machine 100 when bubble level indicator 440 is showing the present state of machine 100 to be at 442 in cautionary state 406.

One of ordinary skill in the art will recognize that any one or more of the displays shown in FIG. 4 may be generated by output device 216 and presented to an operator of machine 100, either on a display within a cab on a machine being operated by a human, or as a video overlay at a remote control (RC) station 401 being used to operate machine 100. In addition, or alternatively, controller 200 may be configured to inform an operator of present and potential future degrees of instability of machine 100, caused by changes in operational parameters such as the amount or weight of a payload being lifted by machine 100, lift height of the payload, articulation angle for an articulated machine, speed and acceleration of machine 100, and pitch angle and roll angle of machine 100 with respect to gravity, through the use of audible signals, for example, that may change in sound, frequency, amplitude, or other characteristics to inform an operator of present and potential future degrees of instability of machine 100. In still further variations or alternative embodiments, controller 200 may be configured to automatically implement changes to operational parameters, including active control of braking, acceleration, or other means for changing the amount of retardation of movement of machine 100, such as dynamic braking or regenerative braking, depending on present and potential future degrees of instability of machine 100.

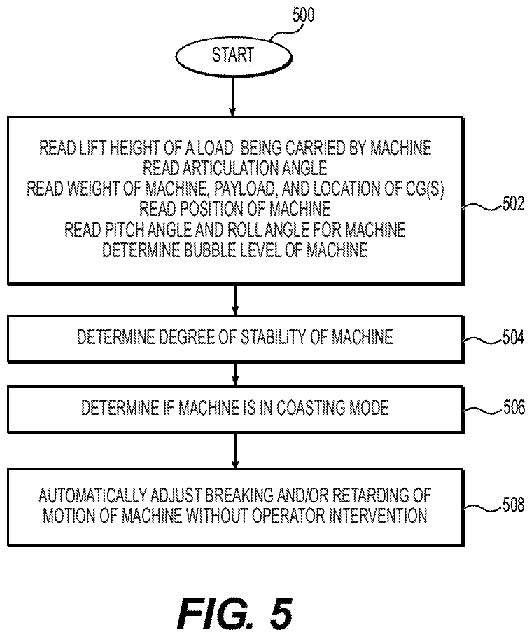

As shown in the flowchart of FIG. 5, other alternative embodiments of the present disclosure may include controller 200 being configured to determine present and potential future degrees of instability of machine 100 (Steps 502 and 504), determine whether machine 100 is in a coasting mode (Step 506), and then automatically adjust braking and/or retarding of motion of machine 100 without any operator intervention (Step 508). The logic of FIGS. 3 and 5 may be performed frequently enough to provide the desired resolution and time responsiveness for determining and alerting at least one of an operator, a service organization, a customer, and an owner of machine 100 of an instability event or machine state, and preferably performed frequently enough to warn the operator of the instability event in time that he or she may take action to prevent a tip-over of machine 100.

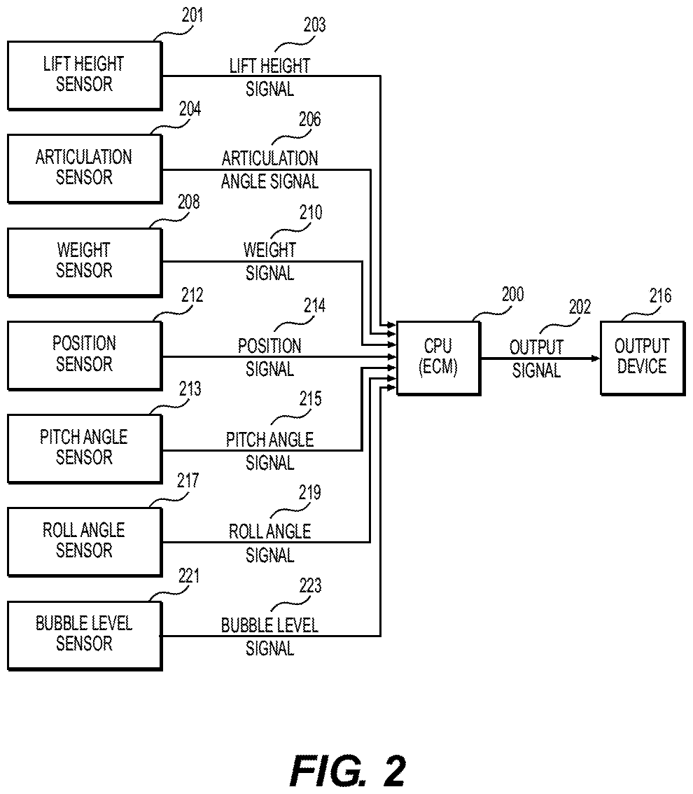

Various sensors (see FIG. 2) may be added or removed depending on the particular machine application and configuration. The sensors may include Inertial Measurement Units (IMU's), which are electronic devices that measure and report a body's specific force, angular rate of momentum, and orientation, using a combination of accelerometers, gyroscopes, and sometimes magnetometers, various perception sensors included as part of a vision system, position and/or velocity sensors, such as an upper structure position/velocity sensor, a laser catcher sensor configured to provide a signal indicative of position as measured by a laser, a cylinder position sensor, hydraulic system sensors, electrical system sensors, braking system sensors, fuel system sensors, and other sensors providing real time inputs to controller (CPU) 200 for use in performing the functions described above in determining present and future degrees of instability of machine 100, and for monitoring the status of and controlling the operation of the systems and subsystems of machine 100.

Machine 100 may be any type of machine configured to perform some type of operation associated with an industry such as mining, construction, farming, transportation, power generation, or any other industry known in the art. As discussed above, an articulated machine such as a wheel loader may particularly benefit from the systems and methods of this disclosure. In some embodiments, machine 100 may be an earth moving machine such as a wheel loader, a backhoe, an excavator, a motor grader, a wheel tractor scraper or any other earth moving machine. Machine 100 may generally include track assemblies or other traction devices (i.e., ground engagement devices) that are mounted on a car body (in between the track assemblies), which supports a frame on which the machine body forming an upper structure may be mounted. The frame and machine body may support an operator station or cab, an integrated display mounted within the cab, operator controls (such as integrated joysticks mounted within the cab), and one or more engines and drive trains that drive the traction devices to propel machine 100. Front frame 110 of wheel loader 100 may be connected to rear frame 112 at an articulation joint 114, as shown in FIG. 1. A bucket of wheel loader 100 may be mounted at a distal end of front frame 110, optionally articulated relative to the front frame 110 by one or more fluid actuation cylinders, electric motors, or other electro-mechanical components, and provided with ground engagement tools or other attachments for performing various tasks.

As discussed above, FIG. 2 is a block diagram of an exemplary embodiment of a sensor fusion system according to the present disclosure. The sensor fusion system may be configured to provide accurate, real time outputs to a machine state control system, which may be associated with or part of output device 216, and which may be configured for controlling various operational aspects of machine 100. The sensor fusion system may be configured to receive signals from a plurality of sensors, as well as signals indicative of various operator commands, such as signals generated by an operator's movement of a joystick or other input device or operator control. “Sensor fusion” is the combining of the sensory data or data derived from disparate sources such that the resulting information has less uncertainty than would be possible when the sources were used individually. The sensor fusion system may also be configured to receive information on the dimensional design of the particular machine with which the sensor fusion system is associated from a dimensional design information database. The particular dimensional design information received from the design information database for a particular machine may be used by a processor associated with the sensor fusion system and configured for deriving the kinematics and dynamics of the machine 100 in conjunction with a kinematics library module and/or through the empirical derivation of the kinematics and dynamics using physics-based equations and algorithms. The various sensors and processors may be connected to each other via any suitable architecture, including any combination of wired and/or wireless networks. Additionally, such networks may be integrated into any local area network (LAN), wide area network (WAN), and/or the Internet.

When the sensors include one or more IMU's, the IMU's may be applied to the machine in multiple different positions and orientations, including on different portions of the machine body, the front frame 110, the rear frame 112, and the bucket. The IMU's may be retrofitted at multiple positions and orientations along each of the portions of the machine, and may be added and removed depending on a particular machine application and configuration. Raw data received from each IMU may be processed through a Kalman filter. In some implementations the Kalman filter for each IMU sensor may be included as part of the IMU, and in other implementations the Kalman filter may be part of a separate sensor fusion module provided as part of a separate sensor fusion system.

Gyroscopes of each IMU sense orientation through angular velocity changes, while accelerometers of each IMU sense changes in direction with respect to gravity. The gyroscope measurements have a tendency to drift over time because they only sense changes and have no fixed frame of reference. The addition of accelerometer data allows bias in the gyroscope data to be minimized and better estimated to reduce propagating error and improve orientation readings. The accelerometers may provide data that is more accurate in static calculations, when the system is closer to a fixed reference point, while the gyroscopes are better at detecting orientation when the system is already in motion. Signals indicative of linear acceleration and angular rate of motion received from the accelerometers and gyroscopes of the IMU's associated with each of the different portions and/or components of the machine may be combined by the Kalman filter(s) to more accurately predict the output angle, velocity, and acceleration of each of the separate components of the machine.

The Kalman filter associated with each IMU or other sensor mounted on a separate machine component takes measured values and finds estimates of future values by varying an averaging factor to optimize the weight assigned to estimated or predicted values as compared to the weight assigned to actual measured values, thereby converging on the best estimates of the true values for position, velocity, and acceleration for each component of the machine. The averaging factor may be weighed by a measure of predicted uncertainty, sometimes called the covariance, to pick a value somewhere between the predicted and measured values. The Kalman filter estimates a machine state by using a form of feedback control in a recursive and iterative process, with each iteration including a time update or “predict” phase, and a measurement or “correct phase”. During each iteration performed by the Kalman filter, a “gain” or weighting is determined by comparing an error in the estimate for a measured value and an error in the actual measurement of the value. The Kalman gain is equal to the ratio between the error in the estimate and the sum of the error in the estimate and the error in the actual measurement. A current estimate for the value is then calculated from the previous estimate and a new measured value. A new error in the estimate of the value is then determined and fed back for use in determining the gain to be applied in the next iteration. The combined or fused information provided by the Kalman filter may provide accurate, real time information on pitch rate, yaw rate, roll rate, boom angle, stick angle, and other angles depending on linkage configuration and the number of IMU's installed on different portions or components of the machine.

As shown in the exemplary embodiment of FIG. 2, a Kalman filter of a sensor fusion system according to this disclosure may be configured to estimate bias of gyroscope information provided by the IMU's, such as the pitch rate, the yaw rate, and the roll rate of each of the components. Because the linear positions and angular positions of points on each of the components are calculated by twice integrating linear accelerations and angular rates of motion from the IMU's, the calculated information can drift over time, deviating more and more from the actual positions as small errors in the measurements are magnified by the integrations. Therefore, the gyroscope biasing aspect of the Kalman filter increases the accuracy of the joint angles calculated from the information provided by the IMU's. The output joint angles for each of the individual portions or components of the machine may be fused with each other at a machine level in order to account for movement of two or more components relative to the machine while the two or more components remain in a substantially fixed orientation relative to each other. For example, both an IMU sensor on first frame 110 of a machine 100 illustrated in FIG. 1, and an IMU sensor on articulation joint 114 or on second frame 112 may indicate a change in output joint angles relative to a global reference frame when first frame 110 moves in a first direction, however the actual angle between the portions of machine 100 may not have changed. Fusing the output joint angles for each of the frames of an articulated machine at a machine level will provide this information so that actual positions of different points on the separate machine components relative to a machine reference frame and a global reference frame can be determined in real time.

The output joint angles that have been fused at the machine level by a Kalman filter may be received by a kinematic library module, which may be associated with or part of controller (CPU) 200. The kinematics library module may be configured to receive the output joint angles from the Kalman filter(s) and dimensional design information specific to the machine 100 from a dimensional design information database, and solve for a frame rotation and position at each component or point of interest on the machine. Each frame 110, 112 can have offsets applied to the information derived from the IMU's in order to solve for any particular point on the machine, and all of the updated position information can be provided to a machine state control system, which may be associated with or programmed as part of controller 200.

In the case of an excavator or other machine where IMU's may be mounted on portions of the machine that are rotated or swung through an arc during operation, the 3 dimensional position information associated with each of the IMU's mounted on those portions of the machine may also be fed back to a swing compensation module. The swing compensation module may be configured to correct the acceleration information provided by the IMU's mounted on the rotating or swinging portions of the machine by compensating for centripetal acceleration. This correction of the acceleration information received from the IMU's may be performed before the information is provided to the Kalman filter.

The additional non-IMU sensors may include any devices capable of generating signals indicative of parametric values or machine parameters associated with performance of the machine 100. For example, the non-IMU sensors may include sensors configured to produce signals indicative of the velocity and position of various elements of the machine in global and machine reference frames, work tool angle, or other interrelationships between portions of machine 100, such as frame 110, articulation joint 114, and frame 112. A payload sensor may also be included and configured to provide a signal indicative of a payload of the machine 100. A slip detector may be included and configured to provide a signal indicative of a slip of the machine 100. Additional non-IMU sensors may include devices capable of providing signals indicative of a slope of the ground on which the machine 100 is operating, an outside temperature, tire pressure if the traction device for machine 100 is a wheel, hydraulic or pneumatic pressures in various fluid actuation control devices, electrical voltages, currents, and/or power being supplied to electrical control devices, etc.

The non-IMU sensors may include one or more locating devices capable of providing signals indicative of the machine's location and/or the position of various components of the machine relative to a global or local frame of reference. For example, a locating device could embody a global satellite system device (e.g., a GPS or GNSS device) that receives or determines positional information associated with machine 100, and may provide an independent measurement of the machine's position. The locating device and any other non-IMU sensor may be configured to convey signals indicative of the received or determined positional information, or other information relating to various machine operational parameters to one or more interface devices such as an integrated display in the operator cab for display of real time machine operating characteristics. The signals from the IMU's and non-IMU sensors may be directed to controller 200 configured to include a Kalman filter, and the Kalman filter may be configured for implementation by one or more processors associated with storage and memory. The one or more processors of controller 200 may be configured to implement a Kalman filtering process including sensor fusion performed in a sensor fusion module. The Kalman filter may also be configured to perform gyroscope bias estimation in a gyroscope bias estimation module in order to compensate for any drift over time in the readings provided by one or more gyroscopes associated with the IMU's. In some exemplary embodiments, a locating device may receive a GPS signal as the location signal indicative of the location of the machine 100 and provide the received location signal to controller 200 for further processing. Additionally, the locating device may also provide an uncertainty measure associated with the location signal. However, it will be understood by one of ordinary skill in the art that the disclosed exemplary embodiments could be modified to utilize other indicators of the location of the machine 100, if desired.

The sensors may also include one or more perception sensors, which may include any device that is capable of providing scene data describing an environment in the vicinity of the machine 100. A perception sensor may embody a device that detects and ranges objects located 360 degrees around the machine 100. For example, a perception sensor may be embodied by a LIDAR device, a RADAR (radio detection and ranging) device, a SONAR (sound navigation and ranging) device, a camera device, or another device known in the art. In one example, a perception sensor may include an emitter that emits a detection beam, and an associated receiver that receives a reflection of that detection beam. Based on characteristics of the reflected beam, a distance and a direction from an actual sensing location of the perception sensor on the machine 100 to a portion of a sensed physical object may be determined. By utilizing beams in a plurality of directions, the perception sensor may generate a picture of the surroundings of the machine 100. For example, if the perception sensor is embodied by a LIDAR device or another device using multiple laser beams, the perception sensor, such as a laser catcher sensor mounted on first frame 110 and/or second frame 112 of machine 100, may generate a cloud of points as the scene data describing an environment in the vicinity of machine 100. It will be noted that the scene data may be limited to the front side (180 degrees or less) of machine 100 in some embodiments. In other embodiments, the perception sensor may generate scene data for objects located 360 degrees around machine 100.

The various sensors, such as shown in FIG. 2, may include devices that provide angular rates and acceleration of the articulated machine 100 or, more particularly, of components or portions of the machine on which the sensors are mounted. For example, an IMU may include a 6-degree of freedom (6 DOF) IMU. A 6 DOF IMU sensor consists of a 3-axis accelerometer, 3-axis angular rate gyroscopes, and sometimes a 2-axis inclinometer. Each of the IMU's may be retrofitted to an existing machine by welding the IMU to a portion or component of the machine where precise information on the real time position, orientation, and motion of that particular portion or component of the machine is desired. The machine's electronic control module (ECM) (e.g., controller 200) or other machine controller(s) may be programmed to receive signals from the IMU's and implement various machine controls based at least in part on the inputs received from the IMU's. In some exemplary implementations of this disclosure, the controls implemented by an ECM in response to the signals received from the IMU's may include actuation of one or more electrical or electro-hydraulic solenoids that are configured to control the opening and closing of one or more valves regulating the supply of pressurized hydraulic or pneumatic fluid to one or more fluid actuation cylinders. The 3-axis angular rate gyroscopes associated with the IMU's may be configured to provide signals indicative of the pitch rate, yaw rate, and roll rate of machine 100 or of the specific portion of the machine on which the IMU sensor is mounted. The 3-axis accelerometer may be configured to provide signals indicative of the linear acceleration of machine 100 or portion of the machine on which the IMU sensor is mounted, in the x, y, and z directions.

A Kalman filter module may be associated with one or more of the processors of controller 200, storage, and memory, included together in a single device and/or provided separately. A processor may include one or more known processing devices, such as a microprocessor from the Pentium™ or Xeon™ family manufactured by Intel™, the Turion™ family manufactured by AIVID™, any of various processors manufactured by Sun Microsystems, or any other type of processor. The memory may include one or more storage devices configured to store information used by the Kalman filter to perform certain functions related to disclosed embodiments. The storage may include a volatile or non-volatile, magnetic, semiconductor, tape, optical, removable, nonremovable, or other type of storage device or computer-readable medium or device. The storage may store programs and/or other information, such as information related to processing data received from one or more sensors, as discussed in greater detail below.

In one embodiment, the memory may include one or more position estimation programs or subprograms loaded from the storage or elsewhere that, when executed by the processor of controller 200, perform various procedures, operations, or processes consistent with the disclosed embodiments. For example, the memory may include one or more programs that enable the Kalman filter to, among other things, collect data from an odometer, a locating device, a perception sensor, any one or more of the IMU's, and any one or more of the non-IMU sensors, and process the data according to disclosed embodiments, and estimate the position(s) of the machine 100 and various portions and components of the machine in real time based on the processed data.

In certain exemplary embodiments, position estimation programs may enable the Kalman filter to process the received signals to estimate the real time positions and orientations of different portions or components of the machine 100. A Kalman filter implements a method that may be used to determine accurate values of measurements observed over time, such as measurements taken in a time series. The Kalman filter's general operation involves two phases, a propagation or “predict” phase and a measurement or “update” phase. In the predict phase, the value estimate from the previous timestep in the time series is used to generate an a priori value estimate. In the update phase, the a priori estimate calculated in the predict phase is combined with an estimate of the accuracy of the a priori estimate (e.g., the variance or the uncertainty), and a current measurement value to produce a refined a posteriori estimate. The Kalman filter is a multiple-input, multiple output digital filter that can optimally estimate, in real time, the states of a system based on its noisy outputs. These states are all the variables needed to completely describe the system behavior as a function of time (such as position, velocity, voltage levels, and so forth). The multiple noisy outputs can be thought of as a multidimensional signal plus noise, with the system states being the desired unknown signals indicative of the true values for each of the variables. The Kalman filter can be configured to filter the noisy measurements, such as the measurements received as signals from the plurality of IMU's mounted on different portions and components of the machine 100, to estimate desired signals. The estimates derived by the Kalman filter from the signals provided by the IMU's and non-IMU sensors are statistically optimal in the sense that they minimize the mean-square estimation error of the signals. The state uncertainty estimate for the noisy measurements may be determined as a covariance matrix, where each diagonal term of the covariance matrix is the variance or uncertainty of a scalar random variable. A gain schedule module may be configured to calculate weights (or gains) to be used when combining each successive predicted state estimate with a successive actual measurement value to obtain an updated “best” estimate. As the Kalman filter receives multiple measurements over time from the IMU's and the non-IMU sensors, a recursive algorithm of the Kalman filter processes each of the multiple measurements sequentially in time, iteratively repeating itself for each new measurement, and using only values stored from the previous cycle (thereby saving memory and reducing computational time).

In one exemplary embodiment, the memory may include one or more pose estimation programs or subprograms loaded from storage or elsewhere that, when executed by the processor, perform various procedures, operations, or processes consistent with disclosed embodiments. For example, the memory may include one or more programs that enable the Kalman filter to, among other things, collect data from the above-mentioned units and process the data according to disclosed embodiments, and determine a state of the machine 100 based on the processed data.

In certain embodiments, the memory may store program enabling instructions that configure the Kalman filter (more particularly, the processor of controller 200) to implement a method that uses the Kalman filter to estimate a state of the machine 100. In certain exemplary embodiments, the Kalman filter may be configured to utilize the following equations in its calculations. For the propagation or “predict” phase, the Kalman filter may be configured to utilize the following generic equations:

\hat{x}ₖ⁻=Fₖ₋₁\hat{x}ₖ₋₁+Gₖ₋₁uₖ₋₁ (1)

Pₖ⁻=Fₖ₋₁Pₖ₋₁⁺Fₖ₋₁^{T}+Qₖ₋₁ (2)

For the measurement or “update” phase, the Kalman filter may be configured to utilize the following generic equations:

Kₖ=Pₖ₋₁⁻H^{T}(HₖPₖ₋₁⁻Hₖ^{T}+Rₖ)⁻¹ (3)

\hat{x}ₖ⁺=\hat{x}ₖ⁻+Kₖ(yₖ−Hₖ\hat{x}ₖ⁻) (4)

Pₖ⁺=(I−KₖHₖ)Pₖ⁻ (5)

In the above equations, \hat{x}ₖ⁻ may be the a priori state estimate of a certain state variable (e.g., pitch rate, yaw rate, roll rate, position, velocity, etc.) that is calculated based on a value (\hat{x}ₖ₋₁) of the state variable from an immediately preceding time step. F, G, and H may be appropriate state transition matrices. In the measurement or “update” phase, the Kalman filter may calculate the Kalman gain Kₖ utilizing equation (3), in which P is an error covariance matrix and R is a matrix setting forth the variance associated with the different state variables. For example, the values in the R matrix may specify the uncertainty associated with the measurement of a given state variable. In the measurement phase, the Kalman filter may also obtain an independent measure of the state variable and set the independent measure as yₖ. Utilizing the a priori estimate \hat{x}ₖ⁻ from the “predict” phase, measurement yₖ, and the Kalman gain Kₖ (applied from the gain schedule module), the Kalman filter may calculate the a posteriori state estimate \hat{x}ₖ⁺ utilizing equation (4).

In the predict phase of a Kalman filter, the Kalman filter may utilize one or more inputs from one or more IMU' s (such as the linear acceleration values from an accelerometer of an IMU sensor and the angular rates of motion values from a gyroscope of an IMU sensor) and a traction device speed sensor to calculate an a priori state estimate of a certain state variable (e.g., pitch rate, yaw rate, roll rate, position, velocity, etc.). In the predict phase, the Kalman filter may execute equations (1) and (2). For example, in the predict phase, the Kalman filter may calculate \hat{x}ₖ⁻ (a priori state estimate) of one or more state variables using a value (\hat{x}ₖ₋₁) of the state variable from an immediately preceding time step and the inputs from one or more IMU's and/or a traction device speed sensor. In some exemplary implementations, \hat{x}ₖ₋₁ may be obtained from the update phase as the output value of the immediately preceding time step.

Following the predict phase, the Kalman filter may implement the update phase to calculate the a posteriori state estimate \hat{x}ₖ⁺ utilizing, for example, equation (4). For example, the Kalman filter may calculate the a posteriori state estimate \hat{x}ₖ⁺ using the a priori estimate \hat{x}ₖ⁻ from the predict phase, measurement yₖ, and the Kalman gain Kₖ. The Kalman filter may also receive as input, in the update phase, acceleration values from inclinometers of the IMU's and location signals from one or more locating devices such as GPS devices for machines that are visible to satellite.

The Kalman filter may set the input received from a locating device and from the inclinometers of the IMU's as the measurement yₖ in equation (4). Additionally, in an exemplary embodiment where the machine 100 is a machine that includes portions or components that are rotated or swung through arcs during operation, the Kalman filter may receive acceleration values from the IMU's located on the rotating or swinging portion of the machine that have been pre-processed in a swing cancellation module to compensate for centripetal acceleration occurring during the swinging motion. Centripetal acceleration compensation for values from the IMU's may be performed on the raw acceleration data from the IMU's before the acceleration data is utilized in equation (4).

Also, as discussed above, the Kalman filter may be configured to execute equations (3) and (5) in the update phase. Using the above, the Kalman filter may be configured to generate the a posteriori state estimate \hat{x}ₖ⁺ as an output. Without limitation, the a posteriori state estimate \hat{x}ₖ⁺ may include the state of the machine, and may include parameters such as velocity, position, acceleration, orientation, etc.

The Kalman filter is very useful for combining data from several different indirect and noisy measurements to try to estimate variables that are not directly measurable. For example, the gyroscopes of the IMU's measure orientation by integrating angular rates, and therefore the output signals from the gyroscopes may drift over time. The inclinometer and direction heading features (compass) of the IMU's may provide a different noisy, but drift-free measurement of orientation. The Kalman filter may be configured to weight the two sources of information appropriately using weights retrieved from a gain schedule module to make the best use of all the data from each of the sources of information.

In determining the state of the machine 100 using a Kalman filter, the filter may also be configured to consider other operational parameters of the machine 100. For example, if the machine 100 is an articulated wheel loader, the Kalman filter may be configured to consider whether the machine 100 is digging, dumping, swinging in between digging and dumping positions, driving to a new location, etc. When the machine 100 is in one or more of the above operational states, certain parameters of the Kalman filter may be changed to reflect the accuracy or confidence in certain input parameters. For example, when the machine 100 is driving from one location to another, the Kalman filter may be configured to apply a lower weighting (gain) from a gain schedule module to the input from the IMU inclinometers. To lower the weighting applied to the inclinometer input from the IMU's, the Kalman filter may be configured to increase the value of variance ‘R’ associated with the inclinometer input in equation (3). Similarly, when the machine 100 is digging, or lifting payload 102 in a bucket, the Kalman filter may be configured to increase the weighting applied to the inclinometer input to reflect a higher confidence in the accuracy of the inclinometer input. For example, to indicate a higher confidence in the accuracy, the Kalman filter may be configured to apply a higher weighting (gain) from the gain schedule module to the input from the IMU inclinometers and decrease the value of ‘R’ associated with the inclinometer input.

### INDUSTRIAL APPLICABILITY

The disclosed systems and methods for determining and maintaining present and future machine states within acceptable levels of instability may be applicable to any machine or machine system benefiting from accurate, real time detection of the variables needed to completely describe the system behavior as a function of time (such as position, velocity, linear acceleration, and angular rate of motion of each machine component). The disclosed sensor fusion system in conjunction with multiple IMU's and non-IMU sensors retrofittably attached to different portions or components of the machine may provide for improved estimation of the positions and orientations of all of the different machine components by utilizing a Kalman filter associated with each IMU mounted on each of a plurality of machine components.

In some exemplary implementations of the disclosed systems and methods, an articulated machine may include a machine state control system that is configured to determine the real time state and stability of a machine, predict the future stability of the machine based on different potential machine operations, and notify an operator of the present and future stability of the machine at different potential states of the machine. The method implemented by the disclosed system may include receiving, with at least one processor, from each of a plurality of sensors mounted on different elements or portions of the machine, a time series of signals indicative of the positions and orientations for each of the elements or portions of the machine on which one or more of the plurality of sensors are mounted. The method may also include fusing a series of measurements made over time by each of the sensors on the machine with a Kalman filter module of the at least one processor. The fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, a position of the machine, a pitch angle of the machine, and a roll angle of the machine relative to a direction of gravity to form a model for estimating a stability of the machine during a timestep of a series of timesteps. The method implemented by a system according to various embodiments of this disclosure may further include generating the model for estimating the stability of the machine based on an a priori estimate of the location of the center of gravity of a first portion of the machine in combination with the payload carried by the machine relative to a predetermined point, and the location of the center of gravity of a second portion of the machine relative to the predetermined point in a subsequent timestep. The method may still further include combining the a priori estimate of the locations of the centers of gravity of the first and second portions of the machine with an estimate of the accuracy of the a priori estimate and a current measurement value received from the plurality of sensors to produce a refined a posteriori estimate of the locations of the centers of gravity of the first and second portions of the machine, fusing the refined a posteriori estimates of the locations of the centers of gravity of the first and second portions of the machine with each other and in reference to a machine reference frame to determine best estimates of the degree of stability of the machine, and solving a kinematic equation using the best estimates of current degree of stability of the machine and structural design information characterizing the machine. The disclosed system may be configured to determine from the solution of the kinematic equation and other machine operational parameters including speed and acceleration of the machine, a time series of real time and future values for the degree of stability of the machine at successive timesteps of the series of timesteps. The system and method according to various disclosed embodiments may also include outputting a visible or audible indication of the machine's current degree of stability and hypothetical future degrees of stability at different potential states of the machine.

Other embodiments of the systems and methods of this disclosure may include a machine state control system configured to implement a method of determining the real time state and stability of a machine, determining whether the machine is in a coasting mode, predicting the future stability of the machine based on different potential machine states or operations, or comparing real time degrees of instability for the machine to predetermined threshold values for acceptable levels of degrees of instability, and automatically adjusting braking or other machine actions for retarding motion of the machine, such as dynamic braking or regenerative braking, without any operator intervention in order to maintain the degree of instability of the machine within an acceptable range at the different potential machine states or operations. An exemplary method may include receiving, with at least one processor, from each of a plurality of sensors mounted on different elements or portions of the machine, a time series of signals indicative of the positions and orientations for each of the elements or portions of the machine on which one or more of the plurality of sensors are mounted. The method may also include fusing a series of measurements made over time by each of the sensors on the machine with a Kalman filter module of the at least one processor. The fusing of the signals from each one of the plurality of sensors includes bringing together sensor inputs that include machine speed, identification of whether the machine is in a coasting mode, a lift height measurement for a payload carried by the machine, an articulation angle of the machine, a weight of the payload and an overall weight of the machine, a positions of portions of the machine, a pitch angle of the machine, and a roll angle of the machine relative to a direction of gravity to form a model for estimating a stability of the machine during a timestep of a series of timesteps. The method may further include generating the model for estimating the stability or instability of the machine based on an a priori estimate of the location of the center of gravity of a first portion of the machine in combination with the payload carried by the machine relative to a predetermined point, and the location of the center of gravity of a second portion of the machine relative to the predetermined point in a subsequent timestep. The method may still further include combining the a priori estimate of the locations of the centers of gravity of the first and second portions of the machine with an estimate of the accuracy of the a priori estimate and a current measurement value received from the plurality of sensors to produce a refined a posteriori estimate of the locations of the centers of gravity of the first and second portions of the machine, fusing the refined a posteriori estimates of the locations of the centers of gravity of the first and second portions of the machine with each other and in reference to a machine reference frame to determine best estimates of the degree of stability (or instability) of the machine, solving a kinematic equation (or other physics-based equation) or retrieving data from a lookup map or other database using the best estimates of current degree of stability of the machine and structural design information characterizing the machine, and determining from the solution of the kinematic equation or other physics-based equation, or other retrieved data, and other machine operational parameters including speed and whether the machine is in a coasting mode, a time series of real time and future values for the degree of stability of the machine at successive timesteps of the series of timesteps. A system for an articulated machine that is in a coasting mode according to various embodiments of this disclosure may be configured to implement a method that still further includes automatically adjusting braking or other machine actions for retarding motion of the machine without any operator intervention in order to maintain the degree of instability of the machine within an acceptable range at the different potential machine states or operations based on the generated model for estimating a stability of the machine during a timestep of a series of timesteps.

A Kalman filter, such as discussed above, may predict the position of machine 100 or the position of a portion or component of the machine relative to a machine reference frame and relative to a global reference frame. For example, by utilizing the angular rates of motion and predicted velocities, the Kalman filter may predict a position of the machine or component of the machine. As discussed above, the Kalman filter may also calculate an uncertainty for the predicted position that may be set equal to the uncertainty as designated by an error covariance matrix of the Kalman filter. Various positions on the machine may also be determined independently from the IMU's. Having determined the independent position measurements, the Kalman filter may be configured to fuse the predicted position information and the independent position measurement to determine updated position estimates for each location. Kalman filter measurement update equations may be utilized to determine the updated position estimate. Having determined an updated position estimate for the machine 100, the Kalman filter may also determine the biases for each of the IMU's. As discussed above, an example of a bias parameter estimation that may be performed by the Kalman filter is an estimation of the bias of gyroscope determined angular positions after integration of measured angular rates.

In one exemplary application of the machine state control system according to an implementation of this disclosure, accurate, updated, real time information on the positions and orientations (pose) of the machine and portions or components of the machine may provide feedback to an information exchange interface in order to effect machine controls that achieve optimal positioning and operation of the machine and components of the machine for improved productivity and reliability. In some implementations, the feedback may assist an operator by coaching the operator on how to effect controls that result in improved machine footing and stability, and hence improved productivity. In other implementations the information received at the information exchange interface may result in the generation of autonomous or semi-autonomous control command signals that are provided to various machine systems and subsystems for effecting changes in machine pose and changes in the relative positions and orientations of machine components. The fused data from the plurality of sensors may be provided to the information exchange interface in order to effect the generation of control command signals that change the operation of various solenoid actuators, throttle controls, fluid cylinder actuation devices, electrical controls, and motion control devices to result in the optimal positioning of the machine during a digging operation and when lifting and carrying a payload. The information exchange interface may provide accurate and real time updated information to a human operator in some implementations, as well as acting as an information interface with autonomous or semi-autonomous control systems that use the information to process control command signals for operating various machine systems and machine subsystems automatically or semi-automatically.

In operating a machine such as an articulated wheel loader, the machine state control system and methods according to various embodiments of this disclosure may determine from historical and/or empirical data stored in one or more lookup maps or other databases or from solving physics-based equations such as a kinematic equation, regarding the kinematics and dynamics for the wheel loader that various payload lift heights and articulated angles of the machine may result in the machine exceeding acceptable levels of instability at certain speeds and or accelerations, or when the machine is in a coasting mode and is being decelerated. Feedback can also be provided to the information exchange interface regarding the machine pitch and roll so that if the footing is poor underneath the wheels of the wheel loader, the information exchange interface can result in the generation of control command signals that cause a change in the pose of the machine to improve the footing and prevent the machine from pitching and rolling, as well as maneuvering the machine to make full contact with the ground to counteract digging forces. The angle of the bucket or other tool and the leverage being achieved by the particular orientation of the frames of the articulated wheel loader at any particular point in time during a digging operation can also impact the digging efficiency or the ability of the machine to carry a payload. The machine state control system according to this disclosure may provide continually updated feedback information to the information exchange interface regarding the real time efficiency of a linkage position during digging and lifting of a payload, and whether certain operations will result in the machine exceeding an acceptable level of instability. The feedback information may result in a change to the angle of the bucket, tipping of the bucket to release part of the payload and change the location of a center of gravity of the bucket in combination with the front frame of the machine, a change to the lift height of the payload, or a change to the articulation angle of the machine in order to avoid exceeding an acceptable level of instability. When machine controls respond to the information provided at the information exchange interface to implement certain controls that avoid exceeding an acceptable level of instability, the result may be improved comfort and safety for an operator, increased productivity rates, and improved longevity of the machine and reduced down time.

In another exemplary application of the machine state control system according to this disclosure, the sensor fusion system may receive, combine, and process operator command inputs received from operator controls with inputs from IMU's and non-IMU machine sensors that measure linkage position, fluid pressures, engine speed, machine pose, machine component positions and orientations (including pitch rate, yaw rate, and roll rate), inputs from a vision system that includes perception sensors providing signals indicative of the presence and location of objects, and inputs from hydraulic system sensors. In some implementations, the signal inputs from the hydraulic system sensors may be indicative of conditions under which higher pressures for fluid actuation cylinders are needed to avoid stalling. In order to avoid unnecessary stresses on the machine, components, and structures, the machine state control system may be configured to automatically adjust boost pressures of hydraulic pumps and command a controlled ramp up in relief pressure set points for one or more relief valves if possible without causing damage to the machine or creating instabilities. The fused sensor outputs from the sensor fusion system according to various embodiments of this disclosure allow the machine state control system to determine when the machine may be stalling or about to stall during a lifting or digging operation, resulting in the potential for the machine to exceed an acceptable degree of instability. The machine state control system may then determine when and how much to boost relief pressure settings for the relief valve(s) based on the fused sensor feedback information in combination with operator commands.

In one exemplary implementation, a wheel loader may be lifting a heavy load or performing a digging operation, and one or more actuation cylinder(s) may be at their maximum pressure, with the pump output pressure equal to the pressure in the actuation cylinders and one part of the machine stalled relative to another part of the machine. The machine state control system can determine from the accurate, real time fused sensor data being received from the sensor fusion system, including data indicative of the pitch rate, and roll rate for the machine, whether the machine is in an unstable and/or overstressed state. The machine state control system may determine that the relief pressure for the actuation cylinder(s) can be increased in a controlled ramp up to get the part of the machine moving again without exceeding acceptable stress levels, and while maintaining the stability of the machine.

In additional exemplary implementations of the machine state control system according to this disclosure, the machine state control system may output commands to adjust the maximum output pressure of a pump providing pressurized fluid to various fluid actuation cylinders on the machine. The machine state control system receives the fused sensor data from the sensor fusion system, including operator inputs, measured linkage positions, fluid pressures, engine speeds, machine pitch rates and roll rates, and scene data such as the presence and location of objects. The machine state control system may determine what operations are being conducted, and adjust the maximum pressures allowed in the system electronically through high pressure cut offs that are established for different operations. The system can thereby prevent excessive stresses on various components and structures of the machine, and also prevent over-torqueing of the components or slamming of the components into objects at high rates of speed by slowing down pump flow, varying displacement of a hydraulic motor, or overriding valve commands received from operator inputs. For components of a machine, which may include an associated dedicated hydraulic swing circuit for moving frame 110 and the bucket between digging and dumping positions, the hydraulic pressure in the swing circuit or swing motor displacement can be electronically limited in accordance with real time output commands received from the machine state control system. In some implementations, one or more pumps provided in the swing circuit or other hydraulic circuits on the machine may be adaptable to a zero displacement or near-zero displacement operational configuration. The machine state control system according to various embodiments of this disclosure may determine what operations are being conducted, and adjust the displacement of the one or more pumps to a zero or near-zero displacement in certain situations. The displacement of the one or more pumps may be adjusted to a low enough value that only leakage of the system is compensated for, and movement of a linkage by a fluid actuation cylinder supplied by the pump or pumps in a very low displacement mode will not result in overstressing of the linkage or other machine components. In addition to or as an alternative to overriding valve commands or other control commands received from operator inputs in a semi-autonomous mode, the machine state control system may provide feedback directly to an operator through one or more displays associated with the information exchange interface, or through haptic feedback in joysticks, the operator seat, heads-up displays (HUD) projected onto a windshield of the operator cab, or through sounds and other stimuli implemented to coach the operator and improve future operational control commands. Additionally, or alternatively, a machine state control system according to embodiments of this disclosure may be configured to automatically adjust braking or other machine actions for retarding motion of the machine without any operator intervention in order to maintain the degree of instability of the machine within an acceptable range at the different potential machine states or operations based on the generated model for estimating a stability of the machine during a timestep of a series of timesteps.

It will be apparent to those skilled in the art that various modifications and variations can be made to the disclosed methods and systems for determining the real time state and degree of instability of a machine, and future states and degrees of instability of a machine depending on the operations that are performed by the machine. Other embodiments and implementations will be apparent to those skilled in the art from consideration of the specification and practice of the disclosed machine state control system. It is intended that the specification and examples be considered as exemplary only, with a true scope being indicated by the following claims and their equivalents.

What is claimed is:

1. A method of determining the real time state and stability of a machine, determining a threshold value for an acceptable level of the stability of the machine based on different potential machine states or operations, and notifying an operator of the present and future stability of the machine at different potential states of the machine, the method comprising:
receiving, with at least one processor, from each of a plurality of sensors mounted on different elements or portions of the machine, a time series of signals indicative of the positions and orientations for each of the elements or portions of the machine on which one or more of the plurality of sensors are mounted;
fusing a series of measurements made over time by each of the sensors on the machine, wherein the fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, positions of various portions of the machine, a pitch angle of the machine, and a roll angle of the machine relative to a direction of gravity to form a model for estimating a stability of the machine during a timestep of a series of timesteps;
generating the model for estimating the stability of the machine based at least in part on an estimate of the location of the center of gravity of a first portion of the machine in combination with the payload carried by the machine relative to a predetermined point, and the location of the center of gravity of a second portion of the machine relative to the predetermined point in a subsequent timestep;
solving a physics-based equation or retrieving data from a lookup map or other database using the best estimates of a current degree of stability of the machine and structural design information characterizing the machine;
determining from the solution of the physics-based equation or retrieved data and other machine operational parameters including speed and acceleration of the machine, a time series of values for the degree of stability of the machine at successive timesteps of the series of timesteps; and
outputting a visible or audible indication of the machine's current degree of stability and hypothetical future degrees of stability at different potential states of the machine.

2. The method of claim 1, wherein the plurality of sensors includes one or more of Inertial Measurement Units (IMU's) configured to measure and report a body's specific force, angular rate of momentum, and orientation, using a combination of accelerometers and gyroscopes; various perception sensors included as part of a vision system; position or velocity sensors; laser sensors; ultrasonic sensors; cylinder position sensors; hydraulic system sensors; electrical system sensors; braking system sensors; fuel system sensors; and other sensors configured to provide real time inputs to the at least one processor, and for monitoring the status of and controlling the operation of systems and subsystems of the machine.

3. The method of claim 1, wherein the fusing of a series of measurements made over time by each of the sensors on the machine is performed using a Kalman filter module of the at least one processor.

4. The method of claim 3, wherein the fusing of the series of measurements includes combining a priori estimates of the locations of the centers of gravity of the first and second portions of the machine with estimates of the accuracy of the a priori estimates and current measurement values received from the plurality of sensors to produce refined a posteriori estimates of the locations of the centers of gravity of the first and second portions of the machine.

5. The method of claim 4, further including fusing the refined a posteriori estimates of the locations of the centers of gravity of the first and second portions of the machine with each other and in reference to a machine reference frame to determine best estimates of the degree of stability of the machine.

6. The method of claim 5, further including determining a weight to be associated with each successive a priori estimate of the locations of the centers of gravity of the first and second portions of the machine relative to a weight to be associated with each successive a posteriori estimate based on successive actual measured values received from each of the plurality of sensors, and assign a Kalman gain representative of the relative weights by retrieving from a predetermined gain schedule a state covariance matrix representative of the predicted variability in the a priori estimates of the locations of the centers of gravity of the first and second portions of the machine, and an estimated measurements covariance matrix representative of the predicted variability in the actual measurements received from each of the plurality of sensors.

7. The method of claim 1, wherein outputting a visible or audible indication of the machine's current degree of stability and hypothetical future degrees of stability at different potential states of the machine includes presenting to an operator of the machine one or more of an indicator of the effect that lift height of a payload carried by the machine will have on a degree of stability of the machine, an indicator of the effect that articulation angle of the machine will have on a degree of stability of the machine, and a bubble level indicator showing the effect that machine orientation will have on a degree of stability of the machine.

8. The method of claim 7, wherein the outputting of a visible indication of the machine's current degree of stability and hypothetical future degrees of stability at different potential states of the machine includes displaying to an operator one or more of a vertical bar with gradations of color or other visual signifiers along the vertical bar for notifying the operator of varying degrees of stability of the machine as the lift height of the payload carried by the machine is varied, a horizontal bar with gradations of color or other visual signifiers along the horizontal bar for notifying the operator of varying degrees of stability of the machine as the articulation angle of the machine is varied, and a bubble level indicator having concentric rings with gradations of color or other visual signifiers notifying the operator of varying degrees of stability of the machine as the machine orientation is changed.

9. The method of claim 7, wherein the outputting of an audible indication of the machine's current degree of stability and hypothetical future degrees of stability at different potential states of the machine includes varying one or more of a type, a volume, an intensity, an amplitude, or a frequency of a sound to notify operator of the machine one or more of the effect that variations in lift height of a payload carried by the machine will have on a degree of stability of the machine, the effect that variations in articulation angle of the machine will have on a degree of stability of the machine, and the effect that variations in machine orientation, including changes in pitch angle or roll angle of the machine, will have on a degree of stability of the machine.

10. A system for determining the real time state and stability of a machine, determining a threshold value for an acceptable level of the stability of the machine based on different potential machine states or operations, and notifying an operator of the present and future stability of the machine at different potential states or operations of the machine, the system including a plurality of sensors mounted on separate elements or portions of the machine, and at least one processor, wherein the at least one processor is configured to:
receive from each of a plurality of sensors mounted on different elements or portions of the machine, a time series of signals indicative of the positions and orientations for each of the elements or portions of the machine on which one or more of the plurality of sensors are mounted;
fuse a series of measurements made over time by each of the sensors on the machine, wherein the fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, positions of various portions of the machine, a pitch angle of the machine, and a roll angle of the machine relative to a direction of gravity to form a model for estimating a stability of the machine during a timestep of a series of timesteps;
generate the model for estimating the stability of the machine based at least in part on an estimate of the location of the center of gravity of a first portion of the machine in combination with the payload carried by the machine relative to a predetermined point, and the location of the center of gravity of a second portion of the machine relative to the predetermined point in a subsequent timestep;
solve a physics-based equation or retrieve data from a lookup map or other database using the best estimates of a current degree of stability of the machine and structural design information characterizing the machine;
determine from the solution of the physics-based equation or retrieved data and other machine operational parameters including speed and acceleration of the machine, a time series of values for the degree of stability of the machine at successive timesteps of the series of timesteps; and
output a visible or audible indication of the machine's current degree of stability and hypothetical future degrees of stability at different potential states of the machine.

11. The system of claim 10, wherein the plurality of sensors includes one or more of Inertial Measurement Units (IMU's) configured to measure and report a body's specific force, angular rate of momentum, and orientation, using a combination of accelerometers and gyroscopes; various perception sensors included as part of a vision system; position or velocity sensors; laser sensors; ultrasonic sensors; cylinder position sensors; hydraulic system sensors; electrical system sensors; braking system sensors; fuel system sensors; and other sensors configured to provide real time inputs to the at least one processor, and for monitoring the status of and controlling the operation of systems and subsystems of the machine.

12. The system of claim 10, wherein the at least one processor is further configured to fuse a series of measurements made over time by each of the sensors on the machine using a Kalman filter module of the at least one processor.

13. The system of claim 12, wherein the at least one processor is further configured to fuse the series of measurements including combining a priori estimates of the locations of the centers of gravity of the first and second portions of the machine with estimates of the accuracy of the a priori estimates and current measurement values received from the plurality of sensors to produce refined a posteriori estimates of the locations of the centers of gravity of the first and second portions of the machine.

14. The system of claim 13, wherein the at least one processor is further configured to fuse the refined a posteriori estimates of the locations of the centers of gravity of the first and second portions of the machine with each other and in reference to a machine reference frame to determine best estimates of the degree of stability of the machine.

15. The system of claim 14, wherein the at least one processor is further configured to determine a weight to be associated with each successive a priori estimate of the locations of the centers of gravity of the first and second portions of the machine relative to a weight to be associated with each successive a posteriori estimate based on successive actual measured values received from each of the plurality of sensors, and assign a Kalman gain representative of the relative weights by retrieving from a predetermined gain schedule a state covariance matrix representative of the predicted variability in the a priori estimates of the locations of the centers of gravity of the first and second portions of the machine, and an estimated measurements covariance matrix representative of the predicted variability in the actual measurements received from each of the plurality of sensors.

16. The system of claim 10, wherein the at least one processor is configured to output a visible or audible indication of the machine's current degree of stability and hypothetical future degrees of stability at different potential states of the machine by presenting to an operator of the machine one or more of an indicator of the effect that lift height of a payload carried by the machine will have on a degree of stability of the machine, an indicator of the effect that articulation angle of the machine will have on a degree of stability of the machine, and a bubble level indicator showing the effect that machine orientation will have on a degree of stability of the machine.

17. The system of claim 16, wherein the at least one processor is further configured to output a visible indication of the machine's current degree of stability and hypothetical future degrees of stability at different potential states of the machine by displaying to an operator one or more of a vertical bar with gradations of color or other visual signifiers along the vertical bar for notifying the operator of varying degrees of stability of the machine as the lift height of the payload carried by the machine is varied, a horizontal bar with gradations of color or other visual signifiers along the horizontal bar for notifying the operator of varying degrees of stability of the machine as the articulation angle of the machine is varied, and a bubble level indicator having concentric rings with gradations of color or other visual signifiers notifying the operator of varying degrees of stability of the machine as the machine orientation is changed.

18. The system of claim 16, wherein the at least one processor is further configured to output an audible indication of the machine's current degree of stability and hypothetical future degrees of stability at different potential states of the machine by varying one or more of a type, a volume, an intensity, an amplitude, or a frequency of a sound to notify the operator of the machine one or more of the effect that variations in lift height of a payload carried by the machine will have on a degree of stability of the machine, the effect that variations in articulation angle of the machine will have on a degree of stability of the machine, and the effect that variations in machine orientation, including changes in pitch angle or roll angle of the machine, will have on a degree of stability of the machine.

19. An articulated machine including a system for determining the real time state and stability of the machine, predicting the future stability of the machine based on different potential machine operations, and notifying an operator of the future stability of the machine at different potential states of the machine, wherein the system includes a plurality of sensors mounted on separate elements or portions of the machine, and at least one processor, the at least one processor being configured to:
receive from each of a plurality of sensors mounted on different elements or portions of the machine, a time series of signals indicative of the positions and orientations for each of the elements or portions of the machine on which one or more of the plurality of sensors are mounted;
fuse a series of measurements made over time by each of the sensors on the machine, wherein the fusing of the signals from each one of the plurality of sensors includes bringing together sensor inputs that include machine speed and acceleration, a lift height measurement for a payload carried by the machine, an articulation angle of the machine, a weight of the payload and an overall weight of the machine, a position of the machine, a pitch angle of the machine, and a roll angle of the machine relative to a direction of gravity to form a model for estimating a stability of the machine during a timestep of a series of timesteps;
generate the model for estimating the stability of the machine based at least in part on an estimate of the location of the center of gravity of a first portion of the machine in combination with the payload carried by the machine relative to a predetermined point, and the location of the center of gravity of a second portion of the machine relative to the predetermined point in a subsequent timestep;
solve a kinematic equation using the best estimates of a current degree of stability of the machine and structural design information characterizing the machine;
determine from the solution of the kinematic equation and other machine operational parameters including speed and acceleration of the machine, a time series of real time and future values for the degree of stability of the machine at successive timesteps of the series of timesteps; and
output a visible or audible indication of the machine's current degree of stability and hypothetical future degrees of stability at different potential states of the machine.

20. The articulated machine of claim 19, wherein the at least one processor is configured to output a visible or audible indication of the machine's current degree of stability and hypothetical future degrees of stability at different potential states of the machine by presenting to an operator of the machine one or more of an indicator of the effect that lift height of a payload carried by the machine will have on a degree of stability of the machine, an indicator of the effect that articulation angle of the machine will have on a degree of stability of the machine, and a bubble level indicator showing the effect that machine orientation will have on a degree of stability of the machine.
